(19) United States
(12) Patent Application Publication
(10) Pub. No.: US 2021/0254515 A1
(43) Pub. Date: Aug. 19, 2021

(54) VALVETRAIN CONFIGURATIONS FOR MULTILEVEL DYNAMIC SKIP FIRE VARIABLE VALVE LIFT SWITCHING AND CYLINDER DEACTIVATION

(71) Applicant: Tula Technology, Inc., San Jose, CA (US)

(72) Inventor: Elliott A. Ortiz-Soto, San Jose, CA (US)

(21) Appl. No.: 17/175,798

(22) Filed: Feb. 15, 2021

Related U.S. Application Data
(60) Provisional application No. 62/976,521, filed on Feb. 14, 2020.

(51) Int. Cl. F01L 9/10; F01L 1/047; F01L 1/18; F01L 1/46; F01L 13/00; F02B 75/18

(52) U.S. Cl. CPC F01L 9/10; F01L 1/047; F01L 1/181; F01L 2013/0078; F01L 13/0005; F02B 75/18; F01L 2305/00; F01L 1/46

(57) ABSTRACT

The invention relates generally valve train systems for internal combustion engine. More particularly, valve train configurations enable operation of a cylinder with two distinct, non-zero lift profiles and cylinder deactivation.

### BACKGROUND

### Field of the Described Embodiments

The described embodiments relate generally to internal combustion engines and to methods and arrangements for controlling internal combustion engines to operate more efficiently. More particularly, valve train configurations for multilevel dynamic skip fire variable valve lift switching and cylinder deactivation are described.

### Description of the Related Art

The output of many internal combustion engines is controlled by adjusting the mass air charge (MAC) delivered to each fired cylinder. An engine control unit (ECU) directs delivery of the appropriate fuel charge for the commanded MAC. Gasoline fueled engines generally operate with an air/fuel ratio at or near stoichiometry to facilitate conversion of harmful pollutants to more benign compounds in a catalytic converter. Control of the MAC is most easily accomplished by adjusting the throttle position which in turn alters the intake manifold pressure (MAP). However, it should be appreciated that the MAC can be varied using other techniques as well. For example, variable intake valve lift control can be used to adjust the MAC. Adjusting the valve lift has the advantage of reducing pumping losses thereby increasing fuel efficiency, particularly at low or intermediate engine loads.

Over the years there have been a wide variety of efforts made to improve the fuel efficiency of internal combustion engines. One approach that has gained popularity is to vary the displacement of the engine. Most commercially available variable displacement engines effectively “shut down” or “deactivate” some of the cylinders during certain low-load operating conditions. When a cylinder is “deactivated”, its piston typically still reciprocates; however, neither air nor fuel is delivered to the cylinder so the piston does not deliver any net power. Since the cylinders that are shut down do not deliver any power, the proportional load on the remaining cylinders is increased, thereby allowing the remaining cylinders to operate with improved fuel efficiency. Also, the reduction in pumping losses improves overall engine efficiency resulting in further improved fuel efficiency.

Another method of controlling internal combustion engines is skip fire control where selected combustion events are skipped during operation of an internal combustion engine so that other working cycles operate at better efficiency. In general, skip fire engine control contemplates selectively skipping the firing of certain cylinders during selected firing opportunities. Thus, for example, a particular cylinder may be fired during one firing opportunity and then may be skipped during the next firing opportunity and then selectively skipped or fired during the next. From an engine cycle perspective, skip fire control may have different sets of cylinders fixed during sequential engine cycles to generate the same average torque, whereas variable displacement operation deactivates the same set of cylinders. This is contrasted with conventional variable displacement engine operation in which a fixed set of the cylinders are deactivated during certain low-load operating conditions. With skip fire control, cylinders are also preferably deactivated during skipped working cycles in the sense that air is not pumped through the cylinder and no fuel is delivered and/or combusted during skipped working cycles when such valve deactivation mechanisms are available. Often, no air is introduced to the deactivated cylinders during the skipped working cycles thereby reducing pumping losses. The Applicants have filed a number of patent applications generally directed at dynamic skip fire control, where firing decisions are made on a firing opportunity by firing opportunity basis. These include U.S. Pat. Nos. 7,849,835; 7,886,715; 7,954,474; 8,099,224; 8,131,445; 8,131,447; 8,336,521; 8,449,743; 8,511,281; 8,616,181; and pending U.S. patent application Ser. Nos. 13/309,460; 13/654,244; and 14/705,712.

The hardware needed to implement valve lift control and deactivation tends to be relatively expensive. With the valve train hardware currently available, it is not generally possible to dynamically switch among three valve states (two distinct valve lifts and deactivation). Current multilevel dynamic skip fire strategy often employs cylinders with two intake valves operated asymmetrically. That is the two intake valves have asymmetric intake valve lifts or intake ports to achieve multi-level charge, where one high lift valve is deactivated independently, and a low lift valve is coupled to the exhaust valves for full cylinder deactivation. This can negatively impact combustion properties such as swirl and tumble, reducing combustion efficiency and can complicate combustion chamber design.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 shows an embodiment of a valve train configuration capable of variable valve lift and cylinder deactivation using a rocker arm with a two-step switchable roller finger follower.

FIGS. 2A-2C show in more detail a deactivatable hydraulic lash adjuster of the embodiment shown in FIG. 1.

FIGS. 3A-3C show in more detail a dual function oil control valve of the embodiment shown in FIG. 1.

FIG. 4 shows the embodiment of the valve train configuration of FIG. 1 in a low charge or low lift state.

FIG. 5 shows the embodiment of the valve train configuration of FIG. 1 in a high charge or high lift state.

FIG. 6 shows the embodiment of the valve train configuration of FIG. 1 in a deactivated state.

FIG. 7 shows another embodiment of a valve train configuration having a rocker arm with a two-step lift switchable roller finger follower and an electronic switchable hydraulic lash adjuster capable of variable valve lift and cylinder deactivation.

FIG. 8 shows the embodiment of the valve train configuration of FIG. 7 in a low charge or low lift state.

FIG. 9 shows the embodiment of the valve train configuration of FIG. 7 in a high charge or high lift state.

FIG. 10 shows the embodiment of the valve train configuration of FIG. 1 in a deactivated state.

FIG. 11A shows a valve train configuration having a hydraulic deactivatable roller finger follower and a two-lobe camshaft sliding element that is capable of variable valve lift and cylinder deactivation.

FIG. 11B shows in more detail a two lobe camshaft sliding element of the embodiment shown in FIG. 11A.

FIGS. 12A-12D show detailed views of the camshaft sliding element of the embodiment shown in FIG. 11A.

FIG. 13A shows the embodiment of the valve train configuration of FIG. 11A in a low charge or low lift state.

FIG. 13B shows the camshaft sliding element in the low lift state.

FIG. 14A shows the embodiment of the valve train configuration of FIG. 11A in a high charge or high lift state.

FIG. 14B shows the camshaft sliding element in the high lift state.

FIG. 15A shows the embodiment of the valve train configuration of FIG. 11A in a deactivated state.

FIG. 15B shows the camshaft sliding element in the deactivated state.

FIG. 16A shows a valve train configuration having a deactivatable roller finger follower and a two-lobe camshaft sliding element that is capable of variable valve lift and cylinder deactivation.

FIG. 16B shows in more detail a two lobe camshaft sliding element of the embodiment shown in FIG. 16A.

FIGS. 17A and 17B are detailed views of the hydraulic lash adjuster shown in FIG. 16A.

FIGS. 18A-18D are detailed views of the camshaft sliding element of the embodiment shown in FIG. 16A.

FIG. 19A shows the embodiment of the valve train configuration of FIG. 16A in a low charge or low lift state.

FIG. 19B shows the camshaft sliding element in the low lift state.

FIG. 20A shows the embodiment of the valve train configuration of FIG. 16A in a high charge or high lift state.

FIG. 20B shows the camshaft sliding element in the high lift state.

FIG. 21A shows the embodiment of the valve train configuration of FIG. 16A in a deactivated state.

FIG. 21B shows the camshaft sliding element in the deactivated state.

FIG. 22 shows a prior art valve train configuration.

It should also be appreciated that the depictions in the figures are diagrammatic and not to scale.

### DESCRIBED EMBODIMENTS

In this patent application, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

As discussed above, variable displacement engines deactivate certain cylinders when they are not needed to increase fuel efficiency. Such cylinder deactivation reduces engine pumping losses. Similarly, under skip fire control, skipped cylinders may be deactivated during the skipped firing opportunity to help reduce pumping losses. However, in conventional variable displacement and skip fire control, a throttle is often still used to decrease manifold pressure to match the torque output to torque demand, which can result in some pumping losses (albeit significantly reduced losses than might be seen using all cylinder operation).

Another known approach for reducing pumping losses is to implement variable valve lift control. Variable valve lift allows control of the lift height and duration of the opening of a cylinder intake valve. Using variable valve lift, the intake valve can be regulated to control the amount of air or air/fuel mixture entering the cylinder. It will be noted that variable valve lift control can be electronically controlled by the engine control unit (ECU) or some other controller.

Embodiments of valve train configurations described herein include an internal combustion engine having cylinders that can switch among three valve states (two distinct valve lifts and deactivation). A combination of variable valve lift and skip fire/valve deactivation strategies enables operation at high intake manifold air pressure at low and intermediate engine output levels, which can result in improved fuel efficiency while providing desirable NVH characteristics. Skip fire control and variable valve lift control can work cooperatively to substantially minimize pumping losses and optimize cylinder charge to maximize engine fuel efficiency.

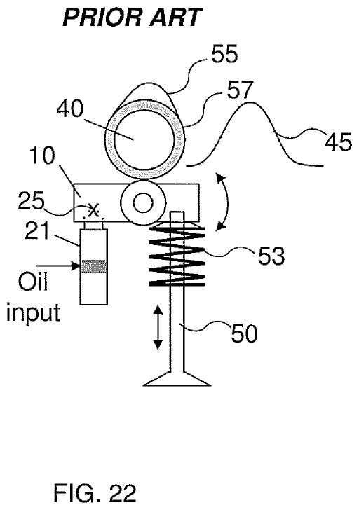

FIG. 22 shows a prior art Type II valve configuration used to control an intake or exhaust valve of an internal combustion engine. The valve 50 is forced upward by the valve spring 53. The valve 50 moves up and down alternating between sealing (up position) and allowing gas to flow into or out of (down position) a cylinder in the internal combustion engine. The valve motion follows a lift profile, depicted by curve 45. Valve 50 motion is caused by rotation of a camshaft 40. The camshaft 40 has a cam lobe 55, which rotates with the camshaft. The cam lobe 55 forces the rocker arm 10 downward when the portion of the cam lobe 55 extending from the base circle 57 contacts the rocker arm 10. The rocker arm 10 pivots about pivot point 25, which is formed at the contact area between the hydraulic lash adjuster (HLA) 21 and the rocker arm 10. Pressurized oil flows into the FILA 21 and upward thru the HLA to the pivot point 25. An oil passage (not shown in FIG. 22) passes thru the pivot point 25 into the rocker arm 10, supplying oil to the rocker arm 10 to reduce friction and wear. The HLA 21 includes an internal mechanism that uses the pressurized oil to force the top of the HLA 21 against the rocker arm 10 reducing or eliminating any lash in the mechanical system. This reduces wear and valve train noise.

In summary, a prior art HLA 21 generally provides three functions: (1) a pivot point for the rocker arm, (2) a lubrication path for the rocker arm, and (3) a lash adjustment mechanism to reduce or eliminate lash in the valve train. In various embodiments of the current invention described herein, the HLA, rocker arm, and cam lobe may be modified from the basic functionality described relative to FIG. 22. These modifications allow the valve train system to provide two distinct non-zero lift profiles to an intake valve and provide the ability to deactivate the intake valve, i.e. leave the intake valve closed thru one or more engine cycles. The described embodiments include valve train configurations having different combinations of a camshaft with two distinct non-zero cam lobes, a switchable two-step rocker arm that can switchably engage with different cam lobes, a deactivatable rocker arm, a deactivatable pivot point, and a camshaft sliding element. These various components may be electrically or hydraulically controlled, as described below.

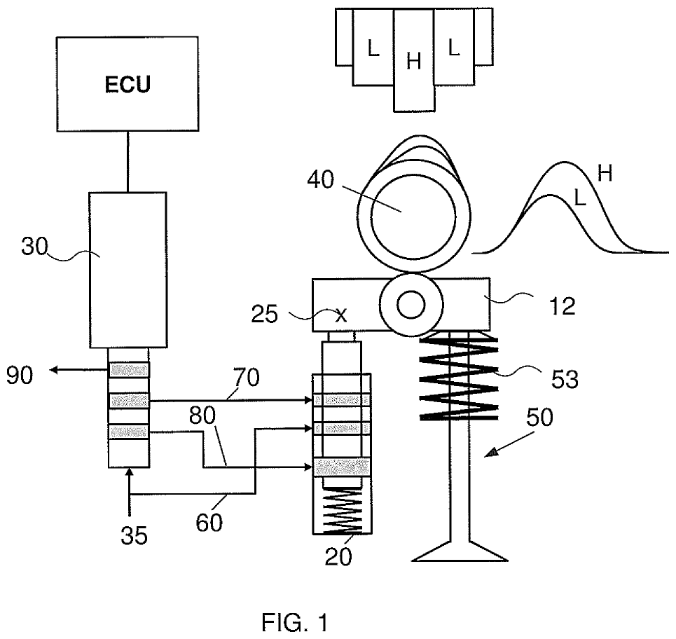

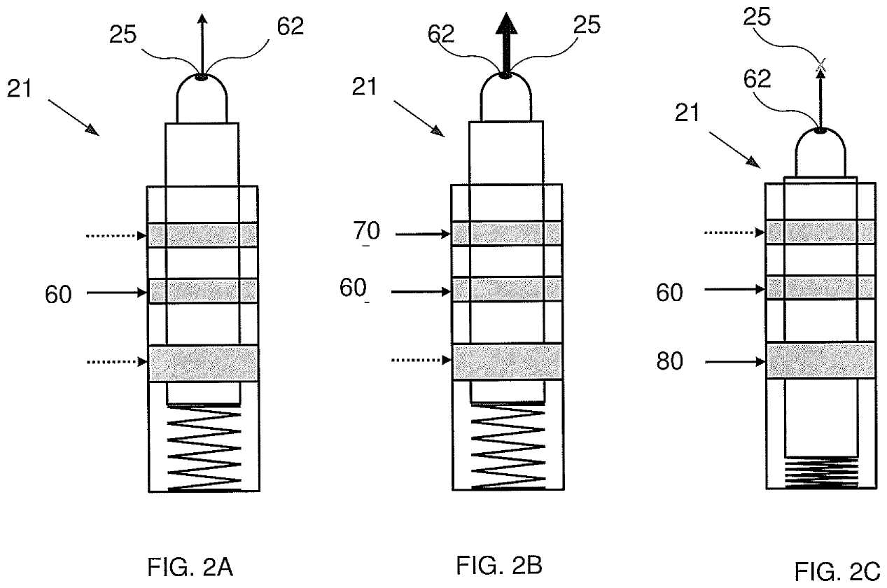

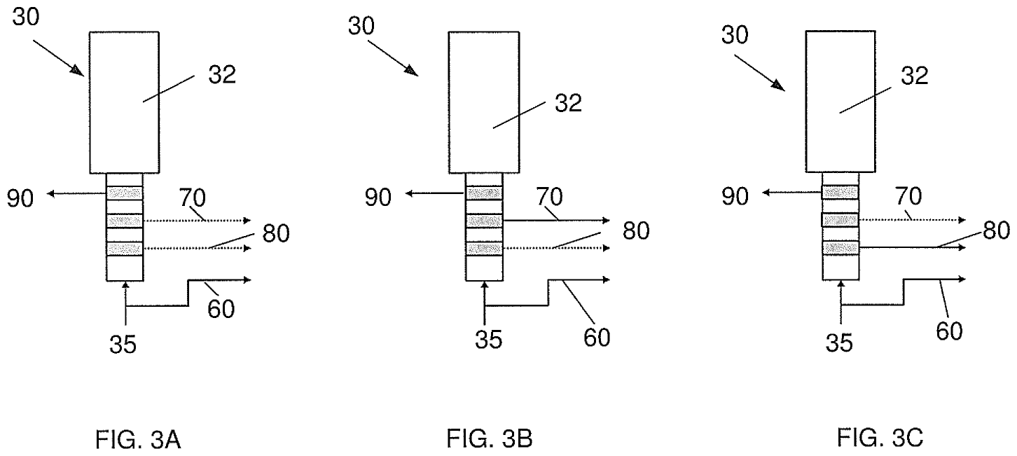

With reference to FIGS. 1-6, a first embodiment of a valve train configuration or valve train system is described. As shown in FIG. 1, the rocker arm (which is a version of rocker arm 10 of FIG. 22) may be a hydraulically controlled two-step, switchable roller finger follower (RFF) rocker arm 12. The rocker arm 12 may pivot about a pivot point 25 in response to being depressed by a cam lobe. Depending on the RFF 12 switch position, the RFF 12 may engage with a first, high lift cam lobe or a second, low lift cam lobe. Engagement with the high lift cam lobe may result in the valve 50 having a high valve lift profile, whereas engagement with the low lift cam lobe may result in the valve 50 having a low valve lift profile. Also included in this embodiment of the valve train configuration may be a hydraulically deactivatable HLA 20 with hydraulic ports provided for RFF 12 lift control and deactivation. The hydraulically deactivatable HLA 20 (which is a version of HLA 21 of FIG. 22) may also provide the standard hydraulic lash adjuster functionality described relative to FIG. 22. The hydraulically deactivatable HLA 20 is shown in more detail in FIGS. 2A-2C. An oil control valve (OCV) may be used to control the hydraulic pressure applied to the hydraulically deactivatable HLA 20. In this embodiment, the OCV 30 is a dual function OCV. The dual function OCV 30 controls an oil supply 35 provided to the hydraulically deactivatable HLA 20. Controlling oil flow to the hydraulically deactivatable HLA 20 enables selection of the high lift valve lift profile, the low lift valve lift profile or valve deactivation. The dual function OCV 30 is shown in more detail in FIGS. 3A-3C. Oil passage 60 allows input oil flow into the hydraulically deactivatable HLA 20 for standard HLA function. Oil flow in oil passage 60 is not controlled by the dual function OCV 30. Oil passage 70 represents an input hydraulic control line to control the state of the two step RFF 12. When oil passage 70 is pressurized by the dual function OCV, the two step RFF 12 may engage with the high lift cam lobe and when oil passage 70 is not pressurized the two step RFF may engage with the low lift cam lobe. Oil passage 80 represents an input hydraulic control line to the hydraulically deactivatable HLA 20 to control valve deactivation. An oil vent/return line 90 is also shown in FIG. 1.

As shown in FIG. 1, a three-lobe camshaft 40 is included in the valve train configuration for raising and lowering the valve 50. As shown in FIG. 1, the valve 50 also includes a spring 53 to force valve 50 upward, which in turn forces the rocker arm 12 to track a cam lobe profile. Also shown are the low lift valve lift profile (L) and high lift valve lift profile (H) profiles caused by engagement of the switchable RFF 12 with either the two low lift cam lobes or high lift cam lobe, respectively. The switchable REF 12 can track either the low lift or high lift profile depending on its switching configuration. Having two low lift cam lobes that are identical within manufacturing tolerances can simplify the design of the switchable RFF 12. It will be appreciated that, in other embodiments, a two-lobe camshaft can be used instead of a three-lobe camshaft, i.e. camshafts having a single low lift cam profile.

FIGS. 2A-2C provide more detailed views of the different lift states of the hydraulically deactivatable HLA 20. The hydraulically deactivatable HLA 20 has a pivot point 25 where it engages with a rocker arm 10 in operation. The pivot point 25 includes lubrication port 62 which provides for lubrication of the rocker arm 10 and other valve train components. FIG. 2A shows the HLA 20 in a low lift state where oil pressure is only applied to the hydraulically deactivatable HLA 20 via oil passage 60. During engine operation oil, is always applied to the hydraulically deactivatable HLA 20 through oil passage 60. Some of the oil present in oil passage 60 is directed to rocker arm lubrication port 62. The oil flow and pressure through lubrication port 62 results in the two step RFF 12 being engaged with the low lift cam lobe. FIG. 2B shows the hydraulically deactivatable HLA 20 in a high lift state where oil pressure is applied to the hydraulically deactivatable HLA 20 via oil passage 70. This increases the oil pressure and flow through lubrication part 62 and causes the two-step switchable RFF 12 to switch from engaging the low lift cam lobe to the high lift cam lobe. FIG. 2C shows the hydraulically deactivatable HLA 20 in a deactivated state. Here oil pressure is applied to hydraulically deactivatable HLA 20 via oil passage 80. Application of oil pressure to oil passage 80 allows the hydraulically deactivatable HLA 20 to compress or collapse so that the rocker arm 12 no longer pivots about the pivot point 25. Oil pressure may or may not be applied to oil passage 70 in the deactivated state. In the deactivated state, rocker arm motion is transferred to the hydraulically deactivatable HLA 20 rather than the valve 50. The hydraulically deactivatable HLA 20 may thus be referred to as a lost motion mechanism, since the hydraulically deactivatable HLA 20 collapses in response to the rocker arm 12 moving over a cam lobe and motion of the valve 50 is lost. Enabling the lost motion mechanism deactivates the cylinder so that it does not induct air and disabling the lost motion mechanism activates the cylinder so that it inducts air.

FIGS. 3A-3C provide more detailed views of the dual function OCV 30, which can be controlled electronically by an engine control unit (ECU). An oil control valve solenoid 32 is controlled by the ECU to actuate the dual function OCV 30. FIG. 3A shows the dual function OCV 30 in a low lift state, FIG. 3B shows the dual function OCV 30 in a high lift state, and FIG. 3C shows the dual function OCV 30 in a deactivated state. As shown in FIG. 3A, in the low lift state, the dual function OCV 30 cuts off oil flow into both oil passages 70 and 80. Oil flow is maintained through oil passage 60 for standard HLA functionality. The OCV configuration depicted in FIG. 3A places the valve train system in a low lift state. As shown in FIG. 3B, the dual function OCV 30 controls the oil flow such that the oil flow is allowed for oil passage 70 but cut off for oil passage 80. The OCV configuration depicted in FIG. 3B places the valve train system in a high lift state. As shown in FIG. 3C, the dual function OCV 30 controls the oil flow such that the oil flow is allowed for oil passage 80. The OCV configuration depicted in FIG. 3C places the valve train system in a deactivated state. Oil flow through oil passage 70 may be either allowed or cut off in the deactivated state (cut off is depicted in FIG. 3C).

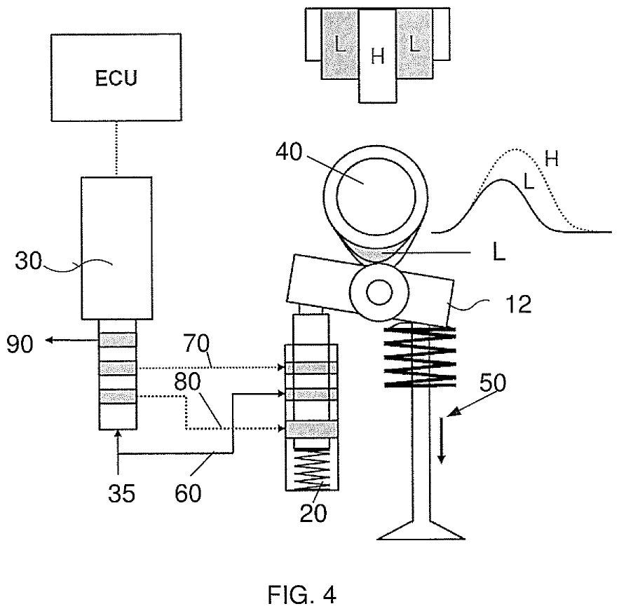

A low charge or low lift state for this embodiment is shown in FIG. 4. In the low lift state, the dual function OCV 30 may be inactive or unpowered such that oil flow to oil passages 70 and 80 is cut off. The hydraulically deactivatable HLA 20 is engaged and operating as would the prior art HLA 21 (FIG. 22). There is only oil flow through oil passage 60 for standard HLA function. This hydraulic configuration places the valve train system in the low lift state as previously described. The rocker arm may be two-step switchable RFF 12 which is switched into the low lift mode in this hydraulic configuration. In this mode, the low lift camshaft lobes L actuate the rocker arm 12. The two low lift camshaft lobes are identical within manufacturing tolerances. As shown in FIG. 4, the valve 50 is opened with a low lift profile.

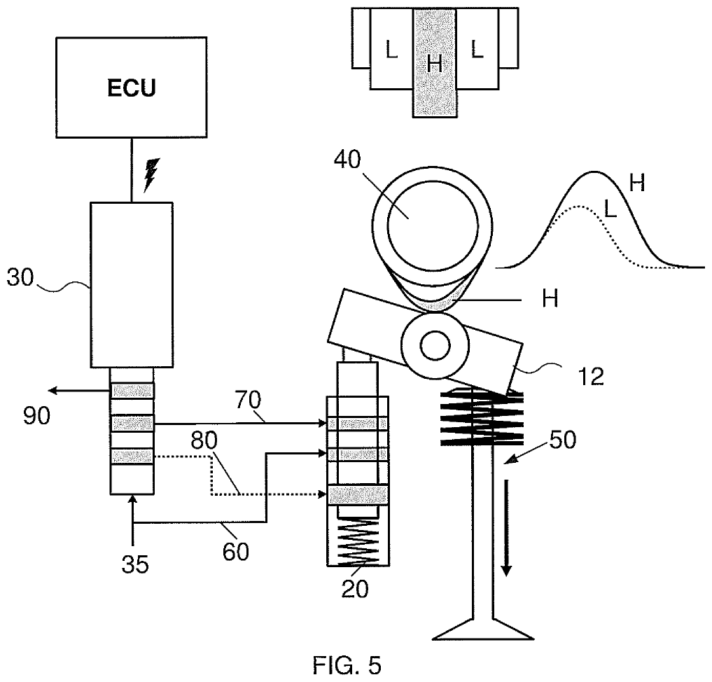

FIG. 5 shows a high charge or high lift state for this embodiment. In the high lift state, the dual function OCV 30 lift control port is active and controls the oil flow such that there is oil flow through oil passage 70 to the two-step switchable RFF 12. This switches the two-step switchable RFF 12 to the high lift state where the high lift cam lobe actuates the two-step switchable RFF 12. In the high lift state as shown in FIG. 5, the hydraulically deactivatable HLA 20 is engaged as would a prior art HLA 21. The rocker arm with a two-step switchable RFF 12 is in a high lift mode with the high lift camshaft lobe H actuating the rocker arm 12. As shown in FIG. 5, the valve 50 is opened with a high lift profile.

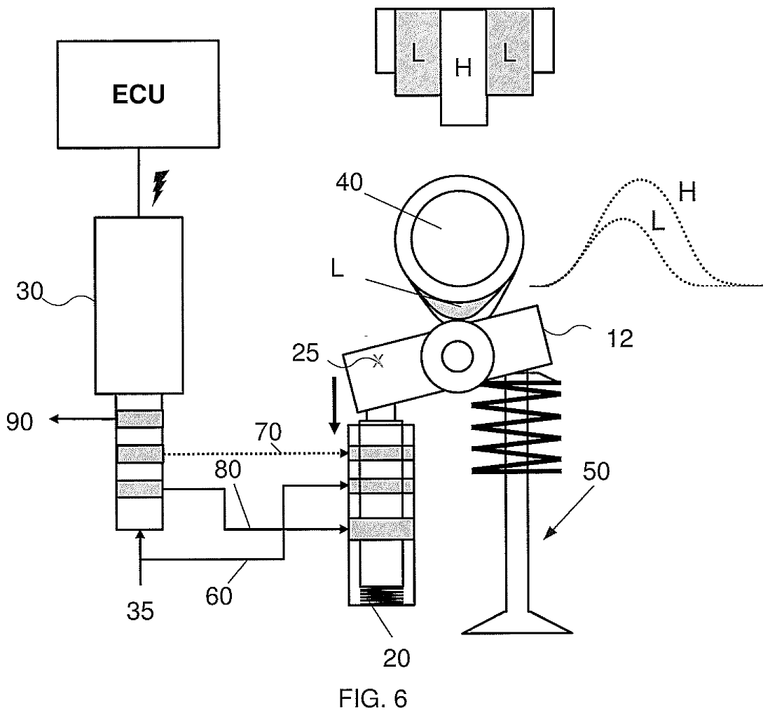

FIG. 6 shows a deactivated state for this embodiment. In the deactivated state, the dual function OCV 30 deactivation port is active and controls the oil flow such that there is oil flow through oil passage 80. This switches the hydraulically deactivatable HLA 20 to the deactivated state. In the deactivated state, the hydraulically deactivatable HLA 20 can collapse as the two-step switchable RFF 12 follows a cam profile. The two-step switchable RFF 12 can be in either a low or high lift mode with the low or high lift camshaft lobe(s) engaging with the rocker arm 10. As shown in FIG. 6, the valve 50 remains closed (both the high (H) and low (L) lift profiles are shown as a dotted line rather than a solid line). Motion of the valve 50 is lost due to the collapse of the hydraulically deactivatable HLA 20, which causes the rocker arm 12 to pivot about the top of the valve 50 rather than the pivot point 25.

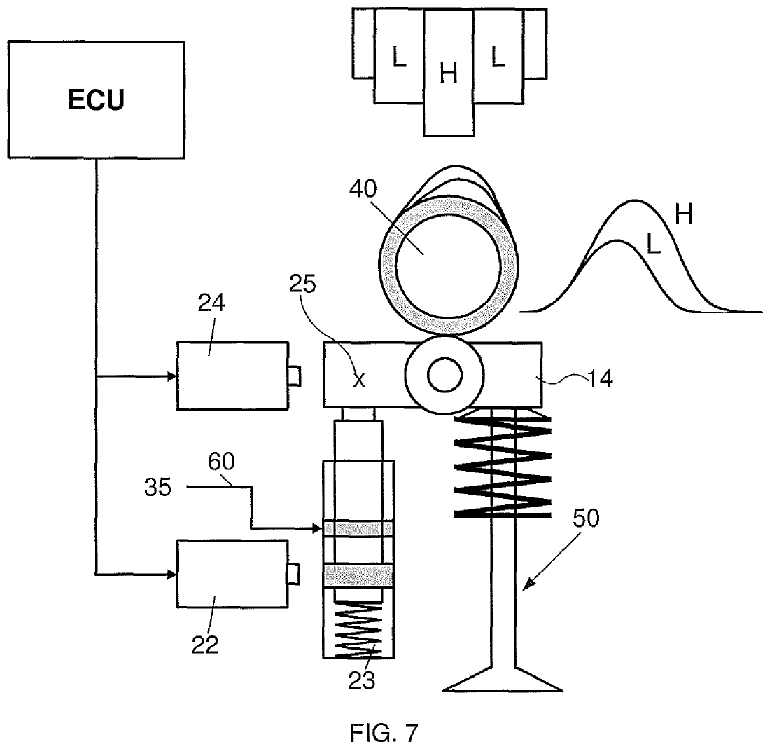

A second embodiment will be described with reference to FIGS. 7-10. According to this embodiment, as shown in FIG. 7, the valve train configuration has a rocker arm (which is a version of rocker arm 10 of FIG. 22) with an electronically controlled two-step switchable RFF 14 and an electronically deactivatable HLA 23 (which is a version of HLA 21 of FIG. 22). The electronically deactivatable HLA 23 is capable of the standard HLA functionality of prior art HLA 21 and is deactivatable by an electromechanical interface (solenoid) 22. The rocker arm with the electronically controlled two-step switchable RFF 14 is controlled via a lift state control electromechanical interface (solenoid) 24. The rocker arm 14 can pivot about the pivot point 25 in response to the rocker arm engaging with a cam lobe, which causes motion of the valve 50. Functioning of the second embodiment shown in FIGS. 7-10 is generally similar to that described relative to FIGS. 1-6, with the hydraulic controls of FIGS. 1-6 replaced by electronic controls.

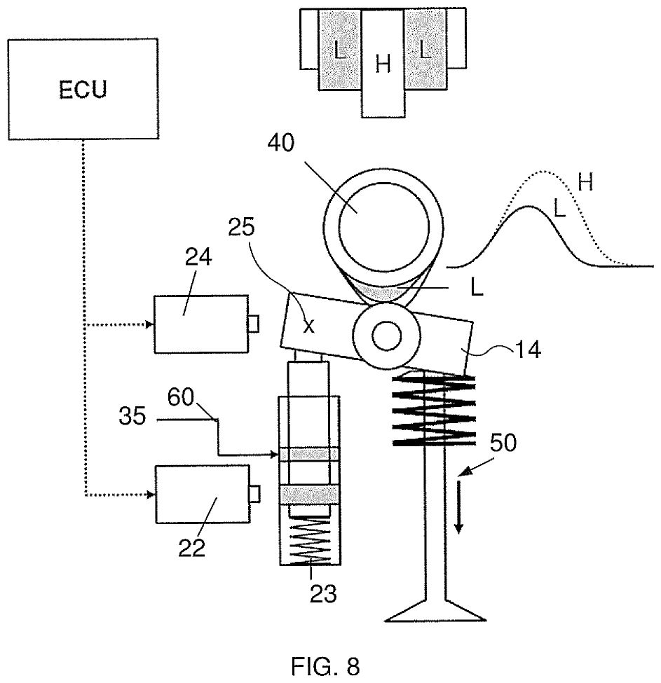

A low charge or low lift state for this embodiment is shown in FIG. 8. In the low lift state, the electromechanical interfaces (solenoids) 22, 24 are inactive and the electronically deactivated HLA 23 is operating to provide lubrication and a pivot point 25 for the rocker arm 14. Thus, there is only oil flow through oil passage 60 for standard HLA functionality. The electronically deactivatable HLA 23 is rigid and the rocker arm 14 pivots about the pivot point 25 as the rocker arm 14 engages with a cam lobe. The electronically controlled two-step switchable RFF 14 is in a low lift mode with the low lift camshaft lobes L actuating the electronically controlled two-step switchable RFF 14. As shown in FIG. 8, the valve 50 is opened with a low lift profile (denoted by the solid L curve and dotted H curve).

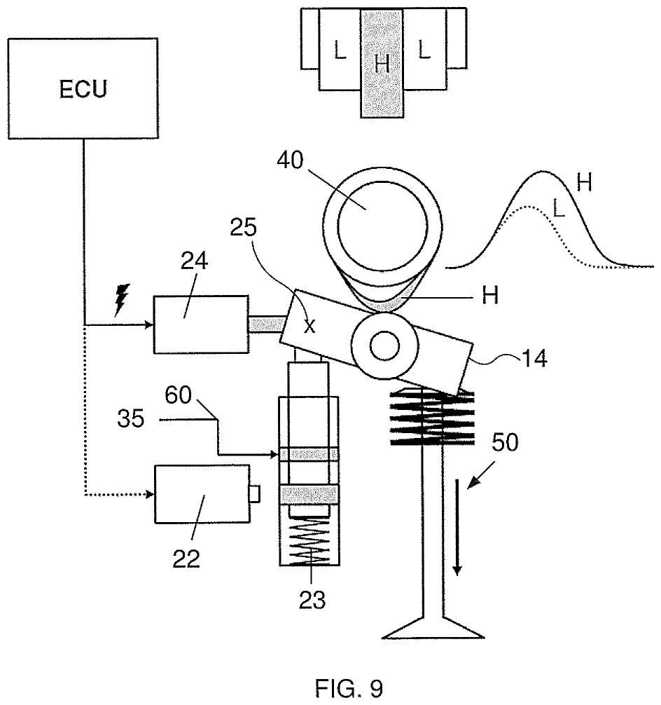

FIG. 9 shows a high charge or high lift state for this embodiment. In the high lift state, the lift state control electromechanical interface (solenoid) 24 is active for the high lift state. The solenoid 24 places electronically controlled two-step switchable RFF 14 in high lift mode with the high lift camshaft lobe H actuating the electronically controlled two-step switchable RFF 14. The solenoid 22 is deactivated, which causes the electronically deactivatable HLA 23 to be rigid. The rocker arm 14 pivots about the pivot point 25 as the rocker arm 14 engages with the high lift cam lobe. As shown in FIG. 9, the valve 50 is opened with a high lift profile (denoted by the solid H curve and dotted L curve).

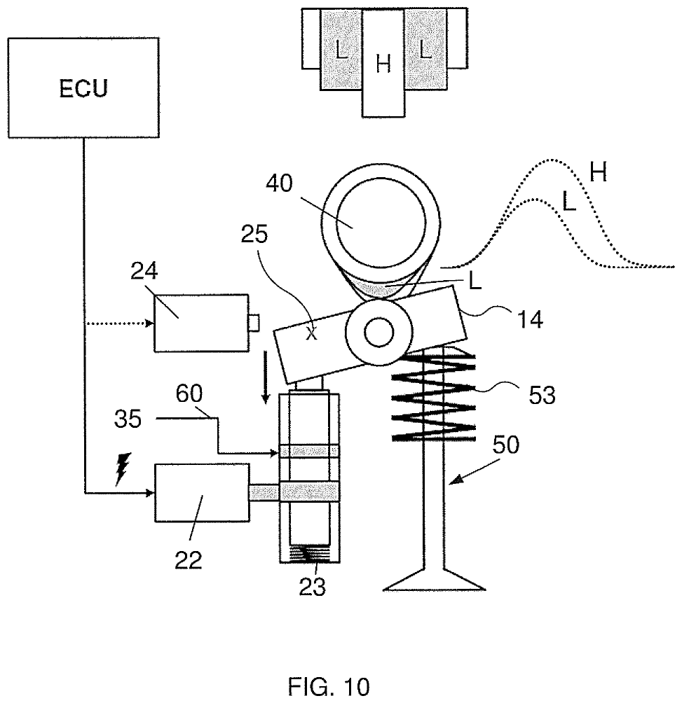

FIG. 10 shows a deactivated state for this embodiment. In the deactivated state, electromechanical interface (solenoid) 22 is active or energized. In the deactivated state, the electronically deactivatable HLA 23 can collapse as the rocker arm 14 follows a cam profile. In the deactivated state, the rocker arm 14 no longer pivots about the pivot point 25. The electronically controlled two-step switchable RFF 14 may be in either a low or high lift mode with the low or high lift camshaft lobe(s) engaging the electronically controlled two-step switchable RFF 14. As shown in FIG. 10, the valve 50 remains closed with lost valve motion transferred to the collapsing electronically deactivated HLA 23. Enabling the lost motion mechanism, in this embodiment collapsing the electronically deactivatable HLA 23, results in cylinder deactivation.

According to other embodiments, the hydraulic control described relative to FIGS. 1-6 may be mixed with the electronic control described relative to FIGS. 7-10. In a third embodiment, the dual function OCV 31 is replaced with a single function OCV that controls the lift state of a hydraulically controlled two-step, switchable RFF rocker arm 12. In this embodiment, a solenoid 22 controls whether an electronically deactivated HLA 23 is rigid or will collapse to deactivate the valve. In a fourth embodiment, a single function OCV controls whether a hydraulically deactivatable HLA 20 is rigid or will collapse to deactivate the valve. In this embodiment, a solenoid 24 controls whether an electrically controlled two-step, switchable RFF rocker arm 14 is actuated by either the high or low lift cam lobe. In both cases, enabling the lost motion mechanism results in cylinder deactivation.

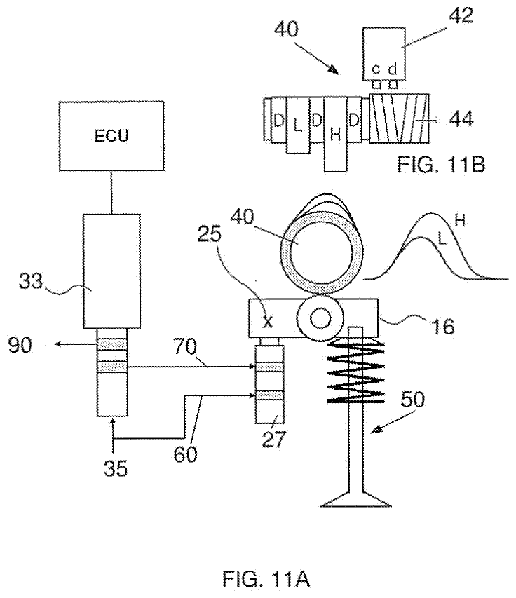

A fifth embodiment will be described with reference to FIGS. 11A-15B. According to this embodiment, as shown in FIG. 11A, a valve train configuration having a camshaft sliding element 40 is described. The rocker arm (which is a version of rocker arm 10 of FIG. 22) may be a hydraulically deactivatable roller finger follower (RFF) rocker arm 16. Oil is provided to the hydraulically deactivatable RFF 16 thru a pivot point 25 of a hydraulic lash adjuster 27. The hydraulic lash adjuster 27 functions as the prior art HLA 21 with the addition of a hydraulic port connected to oil passage 70 to allow hydraulically deactivatable RFF 16 deactivation. When activated the hydraulically deactivatable RFF 16 is rigid and pivots about the pivot point 25 as it engages with a cam profile. When deactivated, the hydraulically deactivatable RFF 16 remains fixed and does not pivot about the pivot point 25 as it engages with a cam lobe. The hydraulically deactivatable RFF 16 may have an internal hinged element that moves in response to cam lobe engagement, but this motion is not transferred to the valve 50. The hydraulically deactivatable RFF 16 may thus be considered a lost motion mechanism wherein the lost motion mechanism is integrated into the rocker arm 16. Enabling the lost motion mechanism results in deactivation of the cylinder.

A single function OCV 33 controls oil flow from oil supply 25 to oil passage 70, which controls the lift state of the hydraulically deactivatable RFF 16 by supplying oil or cutting off the supply of oil. Oil passage 60 provides oil to the hydraulic lash adjuster 27 for standard HLA function. An oil vent/return 90 is also shown in FIG. 11A.

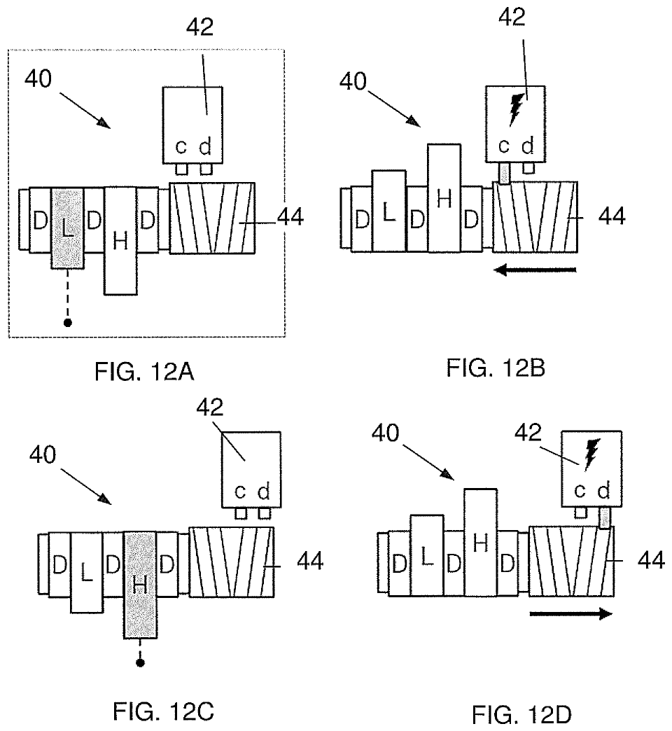

As shown in FIG. 11A, the two-lobe camshaft sliding element 40 is included in the valve train configuration for raising and lowering the valve 50. The camshaft sliding element 40 has a low lift (L) cam lobe and high lift (H) cam lobe. The two-lobe camshaft sliding element 40 is shown in more detail in FIGS. 11B and 12. As shown in FIG. 11A, the valve 50 also includes a spring 53 to force the valve 50 upward unless it is being depressed by the rocker arm 16.

As shown in FIG. 11B, the two-lobe camshaft sliding element 40 has a low lift cam lobe (L) and a high lift cam lobe (H), which may be separated by base circles (D). FIGS. 12A-12D, show more detail regarding operation of the two-lobe sliding element system. FIG. 12A shows the camshaft sliding element 40 in the low lift state with the highlighted low lift lobe L actuating the rocker arm (rocker arm not shown in FIG. 12A). FIG. 12B shows the camshaft sliding element when pin c of solenoid 42 is activated and engaging the camshaft lobe switching river 44 to switch from the low lift state to the high lift state, which is shown in FIG. 12C. The river 44 is a channel into which a solenoid pin is fired which produces an axial motion of the camshaft sliding element 40 as the camshaft rotates with the pin confined to the channel. FIG. 12C shows the camshaft sliding element 40 in the high lift state with the high lift lobe H actuating the rocker arm (rocker arm not shown in FIG. 12C). FIG. 12D shows the camshaft sliding element when pin d of solenoid 42 is activated and engaging the camshaft lobe switching river 44 to switch from the high lift state to the low lift state, which is shown in FIG. 12A.

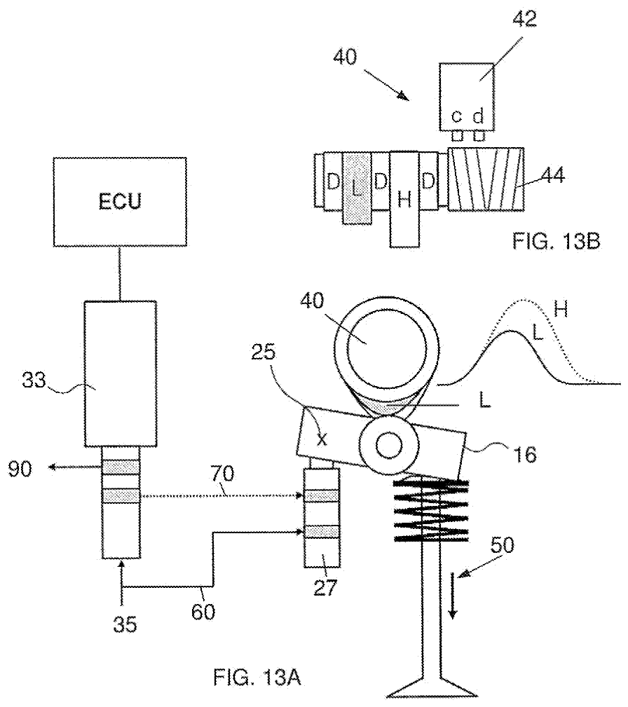

A low charge or low lift state for this embodiment is shown in FIG. 13A. FIG. 13B shows the camshaft sliding element 40 in the low lift state. In the low lift state, the camshaft lobe switching solenoid 42 is inactive (active only when switching between lift states) and the camshaft sliding element 40 is axially positioned so that the low lift cam lobe is engaged with the rocker arm 16. The HLA 27 is providing lubrication and a pivot point 25 for the rocker arm 16. The single function OCV 33 is inactive so that pressurized oil is not being supplied to the HLA 27 through oil passage 70. Thus, there is only oil flow to the HLA 27 through oil passage 60 for standard HLA function. The hydraulically deactivatable RFF 16 is placed into its rigid configuration with the absence of oil pressure in oil passage 70, resulting in the low lift camshaft lobes L actuating the hydraulically deactivatable RFF 16. As shown in FIG. 13A, the valve 50 is opened with a low lift profile.

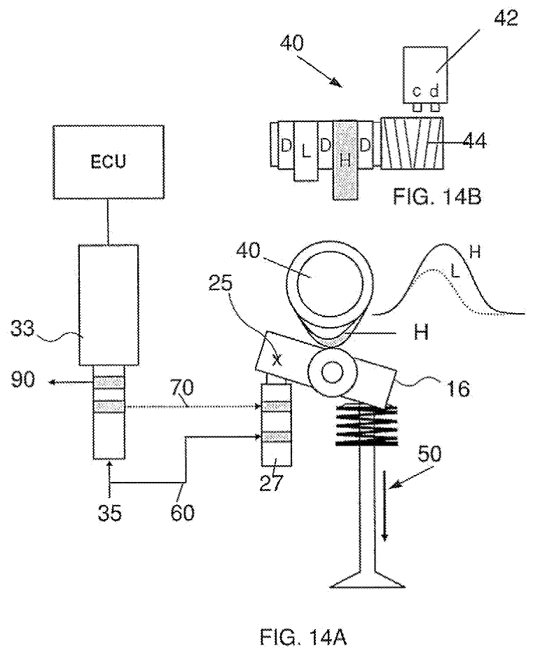

FIG. 14A shows a high charge or high lift state for this embodiment. FIG. 14B shows the camshaft sliding element 40 axially positioned so that the high lift cam lobe can engage with the rocker arm 10. In the high lift state, the camshaft lobe switching solenoid 42 is inactive (active only when switching between lift states) and the camshaft sliding element 40 is axially positioned so that the high lift cam lobe is engaged with the rocker arm 16. The HLA 27 is providing lubrication and a pivot point 25 for the rocker arm 16. The single function OCV 33 is again inactive so that pressurized oil is not supplied to oil passage 70. The HLA 27 receives oil through oil passage 60 to lubricate and provide a pivot point 25 for rocker arm 16. The hydraulically deactivatable RFF 16 is placed into its rigid configuration by the absence of oil pressure in oil passage 70, resulting in the high lift camshaft lobes H actuating the hydraulically deactivatable RFF 16. As shown in FIG. 14A, the valve 50 is opened with a high lift profile.

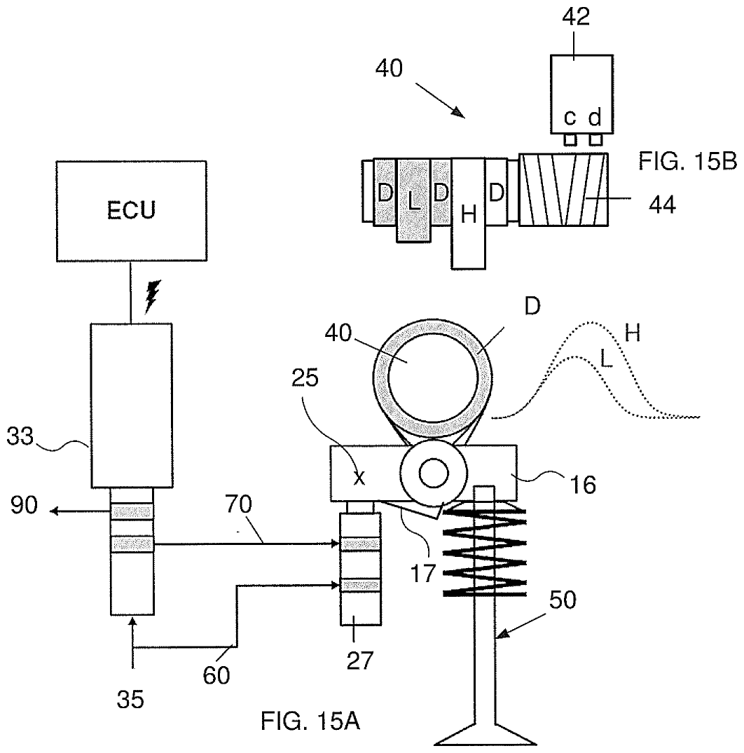

FIG. 15A shows a deactivated state for this embodiment. In the deactivated state, the camshaft lobe switching solenoid 42 is inactive (active only during switching between lift states) with the camshaft sliding element 40 aligned so that either the low lift cam or high lift cam is engaged with the hydraulically deactivatable RFF 16. The camshaft sliding element 40 is shown in a low lift axial position in FIG. 15B, but it could also be in the high lift axial position. The HLA 27 receives oil through oil passage 60 to lubricate the rocker arm 16. Additionally, the HLA 27 receives pressurized oil through oil passage 70 by activation of the single function OCV 33. The pressurized oil is directed through the HLA 27 to the hydraulically deactivatable RFF 16 thru the pivot point 25. The pressurized oil places the hydraulically deactivatable RFF 16 in its deactivated state, wherein the hydraulically deactivatable RFF 16 is no longer rigid but can engage with a cam lobe profile with only internal motion. For example, a hinged element 17 may move downward as shown in FIG. 15A. As shown in FIG. 15A, there may also be contact between some elements of the hydraulically deactivatable RFF 16 and the base circle lobe D. The valve 50 remains closed as the camshaft 40 rotates. The hydraulically deactivatable RFF 16 thus serves to absorb the valve motion that would be typically result from camshaft rotation and thus may be consider a lost motion mechanism. Enabling the lost motion mechanism, in this embodiment the hydraulically deactivatable RFF 16 results in deactivation of the cylinder.

According to a sixth embodiment, the rocker arm 10 can be an electrically deactivated roller finger follower rocker arm. In this embodiment, a solenoid may control whether the electrically deactivated roller finger follower rocker arm is in a rigid, active state or a flexible, deactivated state. This embodiment is similar to that described relative to FIGS. 11A-15B with the hydraulically deactivatable roller finger follower rocker arm replaced by an electrically deactivated roller finger follower rocker arm and the appropriate control mechanisms.

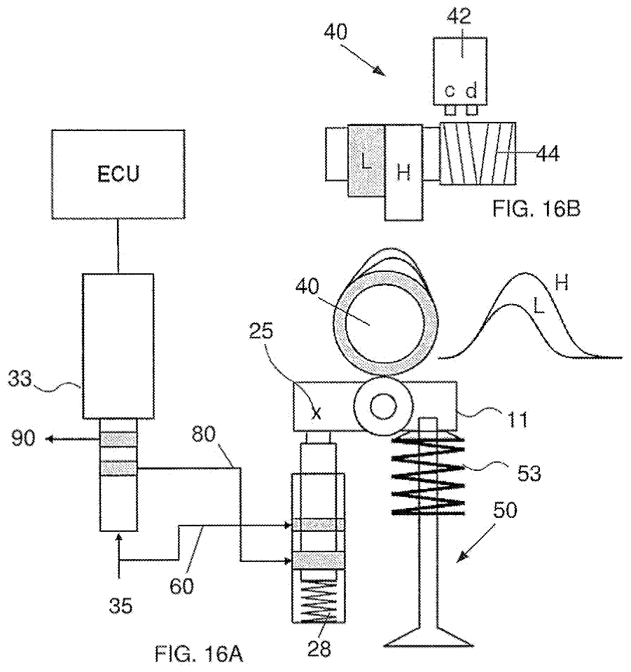

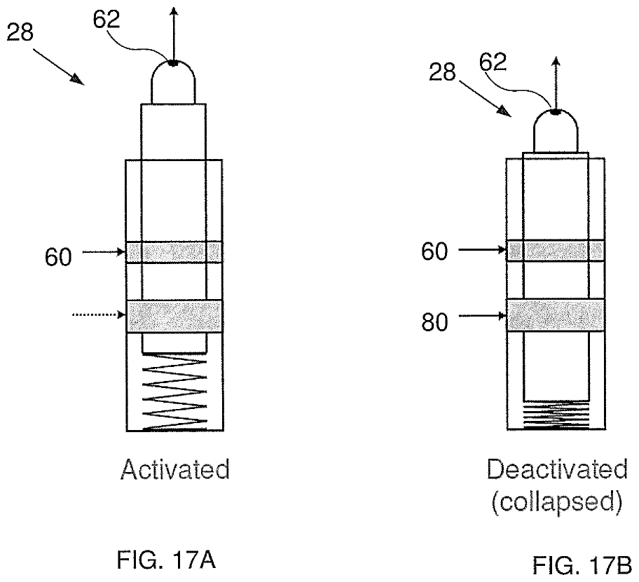

A seventh embodiment will be described with reference to FIGS. 16A-21B. This embodiment is similar to that described relative to FIGS. 11A-15B with the hydraulically deactivatable RFF 16 being replaced with a hydraulically deactivatable HLA 28. As shown in FIG. 16A, the rocker arm is a simple rocker arm 11 with no switching or deactivation capability. Also included in this embodiment of a valve train system is a hydraulically deactivatable HLA 28 with hydraulic ports provided for hydraulically deactivatable HLA 28 activation and deactivation as well as standard HLA function. The hydraulically deactivatable HLA 28 of this embodiment is shown in more detail in FIGS. 17A and 17B. A single function OCV 33 controls the oil supply to oil passage 80, which controls whether the hydraulically deactivatable HLA 28 is in its activated, rigid state or its deactivated, collapsible state. Oil supply 35 is also directed to the hydraulically deactivatable HLA 28 through oil passage 60 for standard HLA function. An oil vent/return 90 is also shown in FIG. 16A. Pivoting of the rocker arm 11 about a pivot point 25 as it is depressed by a cam lobe results in motion of the valve 50. The valve train system also includes a spring 53 to force the valve upward and the rocker arm 10 against a cam profile. Also shown in FIG. 16A are low lift (L) and high lift (H) cam lobe profiles attached to the camshaft 40.

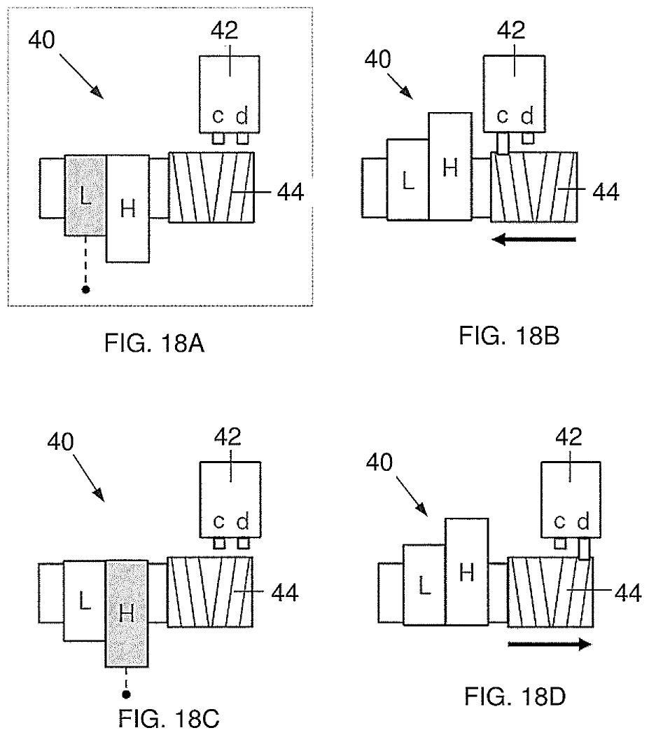

As shown in FIG. 16B, the two-lobe camshaft sliding element 40 has low lift (L) and high lift (H) cam lobes for operating the valve 50 with a low lift and high lift valve lift profile. The two-lobe camshaft sliding element 40 is shown in more detail in FIGS. 18A-18D.

FIG. 17A shows the hydraulically deactivatable HLA 28 in a rigid, activated state and FIG. 17B shows the hydraulically deactivatable HLA 28 in a deactivated or collapsed state. As shown in FIG. 17A, when the hydraulically deactivatable HLA 28 is activated, oil flow through oil passage 60 flows into the hydraulically deactivatable HLA 28 for standard HLA function. Oil may also flow out of lubrication port 62 to provide lubrication for the rocker arm 11. FIG. 17B shows the HLA 28 deactivated, with oil flow in oil passage 80 for hydraulically deactivatable HLA 28 deactivation.

FIGS. 18A-18D, show more detail regarding operation of the two-lobe sliding element system. FIG. 18A shows the camshaft sliding element 40 in the low lift state with the highlighted low lift lobe L actuating the rocker arm (rocker arm not shown in FIG. 18A). FIG. 18B shows the camshaft sliding element when pin c of solenoid 42 is activated and engaging the camshaft lobe switching river 44 to switch from the low lift state to the high lift state, which is shown in FIG. 18C. The river 44 is a channel into which a solenoid pin is fired which produces an axial motion of the camshaft sliding element 40 as the camshaft rotates with the pin confined to the channel. FIG. 18C shows the camshaft sliding element 40 in the high lift state with the high lift lobe H actuating the rocker arm (rocker arm not shown in FIG. 18C). FIG. 18D shows the camshaft sliding element when pin d of solenoid 42 is activated and engaging the camshaft lobe switching river 44 to switch from the high lift state to the low lift state, which is shown in FIG. 18A.

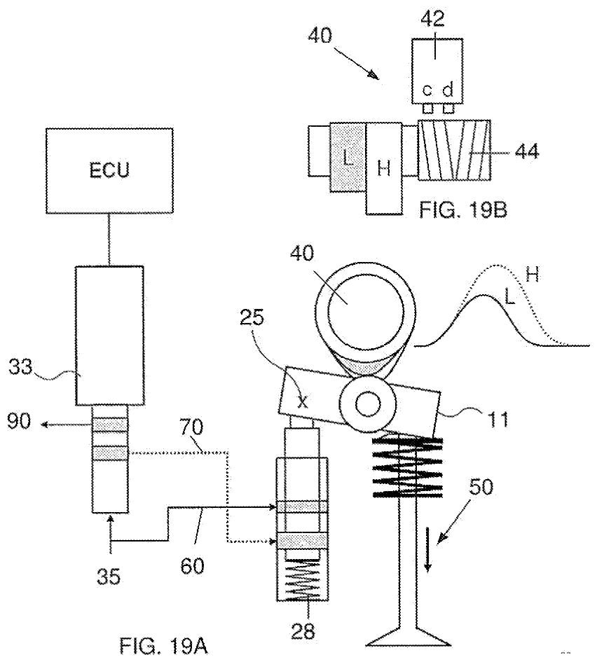

A low charge or low lift state for this embodiment is shown in FIG. 19A. FIG. 19B shows the camshaft sliding element 40 in the low lift state. In the low lift state, the camshaft lobe switching solenoid 42 is inactive (active only when switching between lift states) and the camshaft sliding element 40 is axially positioned so that the low lift cam lobe is engaged with the rocker arm 11. The hydraulically deactivatable HLA 28 is providing lubrication and a pivot point 25 for the rocker arm 11. The single function OCV 33 is inactive so that pressurized oil is not being supplied to the hydraulically deactivatable HLA 28 through oil passage 80. Thus, there is only oil flow to the hydraulically deactivatable HLA 28 through oil passage 60 for standard HLA function. Since the rocker arm is a simple rocker arm 11, the valve 50 motion tracks the low lift cam lobe and the valve 50 is opened with a low lift profile.

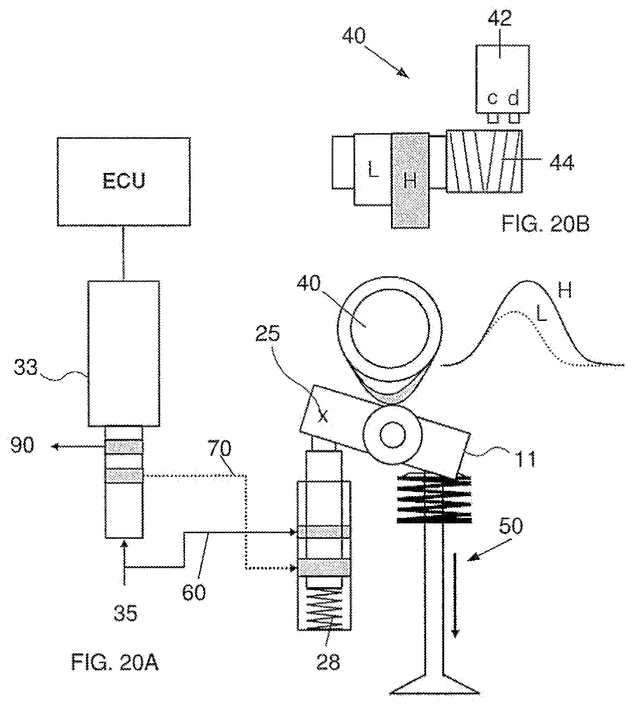

FIG. 20A shows a high charge or high lift state for this embodiment. FIG. 20B shows the camshaft sliding element 40 axially positioned so that the high lift cam lobe can engage with the rocker arm 11. In the high lift state, the camshaft lobe switching solenoid 42 is inactive (active only when switching between lift states). The hydraulically deactivatable HLA 28 is providing lubrication and a pivot point 25 for the rocker arm 11. The single function OCV 33 is again inactive so that pressurized oil is not supplied to oil passage 80. The hydraulically deactivatable HLA 28 receives oil through oil passage 60 to lubricate and provide a pivot point 25 for rocker arm 11. The hydraulically deactivatable HLA 28 is placed into its rigid configuration with the absence of oil pressure in oil passage 80, resulting in the high lift camshaft lobes H actuating the rocker arm 11. As shown in FIG. 20A, the valve 50 is opened with a high lift profile.

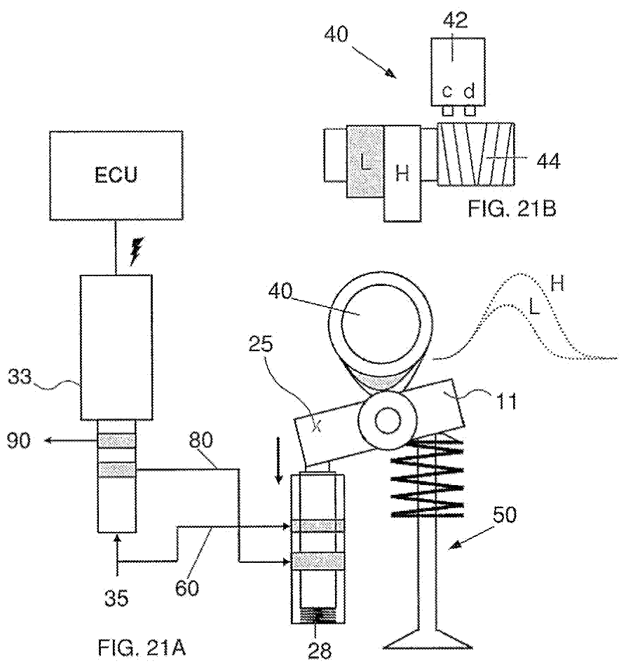

FIG. 21A shows a deactivated state for this embodiment. FIG. 21B shows the camshaft sliding element 40 in the deactivated state. In the deactivated state, the camshaft sliding element 40 may be in either a low lift state or a high lift state (low lift state shown in FIG. 21B), and the hydraulically deactivatable HLA 28 is deactivated. The single function OCV 33 is active and controls the oil flow such that there is oil flow through oil passage 80 through the single function OCV 33 to the hydraulically deactivatable HLA 28 to place it in a deactivated state. As shown in FIG. 21A, the valve 50 is closed with lost motion due to the hydraulically deactivatable HLA 28 collapsing as a cam lobe engages with the rocker arm 11. Enabling the lost motion mechanism, in this embodiment the hydraulically deactivatable HLA 28, results in cylinder deactivation.

In an eighth embodiment, the hydraulically deactivatable HLA 28 and single function OCV 33 described in relation of FIGS. 16A-21B is replaced by an electronically deactivatable HLA and controlling solenoid. An electronically deactivatable HLA and controlling solenoid were previously described in relation to FIG. 7 and for brevity that description will not be repeated here.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings. For example, the invention was generally described in terms of a Type II valve train with an overhead camshaft. The invention is not so limited. It may be used with pushrod type valve trains and other types of valve trains.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of particular embodiments, there are alterations, permutations, and equivalents, which fall within the scope of these general concepts. It should also be noted that there are alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A valve train system of a cylinder in an internal combustion engine, the cylinder having an intake valve, the intake valve capable of being actuated by a cam lobe attached to a camshaft, the valve train system comprising:
a rocker arm that is capable of transferring a profile of the cam lobe into motion of the intake valve; and
a lost motion mechanism that when enabled results in the profile of the cam lobe not being transferred into intake valve motion, thereby deactivating the cylinder,
wherein the cam lobe is one of two distinct non-zero cam lobes that can engage with the rocker arm to cause motion of the intake valve when the lost motion mechanism is disabled thereby activating the cylinder, wherein the cam lobe is a high lift cam lobe or a low lift cam lobe.

2. The valve train system as recited in claim 1, wherein the lost motion mechanism is integrated into the rocker arm.

3. The valve train system as recited in claim 2, wherein the rocker arm is a roller finger follower rocker arm.

4. The valve train system as recited in claim 2, wherein the two distinct non-zero cam lobes are on a sliding camshaft element that is capable of moving axially along the camshaft so that the rocker arm can switchably engage with the high lift cam lobe or the low lift cam lobe.

5. The valve train system as recited in claim 4, wherein the lost motion mechanism is enabled by being hydraulically activated.

6. The valve train system as recited in claim 4, wherein the lost motion mechanism is enabled by being electrically activated.

7. The valve train system as recited in claim 1, wherein the rocker arm rotates about a pivot point when the cylinder is activated and the pivot point collapses when the cylinder is deactivated.

8. The valve train system as recited in claim 7, wherein the rocker arm is a two-step switchable roller finger follower rocker arm that can be switchably engaged with either the high lift cam lobe or the low lift cam lobe.

9. The valve train system as recited in claim 7, wherein the rocker arm switching is hydraulically activated.

10. The valve train system as recited in claim 9, wherein collapsing of the pivot point is hydraulically activated.

11. The valve train system as recited in claim 9, wherein collapsing of the pivot point is electrically activated.

12. The valve train system as recited in claim 7, wherein the rocker arm switching is electrically activated.

13. The valve train system as recited in claim 12, wherein collapsing of the pivot point is hydraulically activated.

14. The valve train system as recited in claim 12, wherein collapsing of the pivot point is electrically activated.

15. The valve train system as recited in claim 7, wherein the two distinct non-zero cam lobes are on a sliding camshaft element that is capable of moving axially along the camshaft so that the rocker arm can switchably engage with the high lift cam lobe or the low lift cam lobe.

16. The valve train system as recited in claim 15, wherein collapsing of the pivot point is hydraulically activated.

17. The valve train system as recited in claim 15, wherein collapsing of the pivot point is electrically activated.

18. The valve train system as recited in claim 7, wherein the pivot point is provided by a hydraulic valve lash adjuster.

19. The valve train system as recited in claim 1, wherein the camshaft has no more than two distinct non-zero cam lobes on the camshaft to engage with the intake valve.

20. The valve train system as recited in claim 1, wherein the internal combustion engine includes a plurality of cylinders and each cylinder in the plurality of cylinders is capable of cylinder deactivation.
